(19) United States
(12) Patent Application Publication
(10) Pub. No.: US 2019/0136835 A1
(43) Pub. Date: May 9, 2019

(54) WIND TURBINE DRIVETRAIN SYSTEM

(71) Applicant: Accelerate Wind, LLC, St. Louis, MO (US)

(72) Inventor: Erika Beth Boeing, St. Louis, MO (US)

(73) Assignee: Accelerate Wind, LLC, St. Louis, MO (US)

(21) Appl. No.: 16/177,086

(22) Filed: Oct. 31, 2018

Related U.S. Application Data
(60) Provisional application No. 62/580,212, filed on Nov. 1, 2017.

(51) Int. Cl. F03D 15/00; F03D 9/12; F03D 9/25; F03D 7/02

(52) U.S. Cl. CPC F03D 15/00; F03D 9/12; F03D 9/255; F03D 7/0284; F03D 7/0224; F05B 2270/337; F05B 2260/421; F05B 2260/70; F05B 2260/90; F05B 2270/1033; F05B 2270/328; F05B 2260/4031

(57) ABSTRACT

A system for a wind turbine, the system includes a rotor connected to a plurality of blades, a continuously variable transmission (CVT), a flywheel and a generator. The rotor has a rotor-outputted rotational energy and is coupled to the CVT by a first mechanical coupling. The CVT outputs a CVT-outputted rotational energy and is coupled to the flywheel by a second mechanical coupling. The flywheel outputs a flywheel-outputted rotational energy and is coupled to the generator by a third mechanical coupling. The generator produces an electrical output based upon the flywheel-outputted rotational energy received from the third mechanical coupling. A controller is in electrical communication with the CVT and modulates the CVT ratio in response to a signal from the controller.

### CROSS REFERENCE TO RELATED APPLICATION

This application claims the benefit of and incorporates by reference the entirety of U.S. Provisional Patent Application No. 62/580,212 filed on Nov. 1, 2017.

### STATEMENT REGARDING FEDERALLY SPONSORED RESEARCH OR DEVELOPMENT

Not applicable.

### SEQUENCE LISTING, TABLE OR COMPUTER PROGRAM ON COMPACT DISC

Not applicable.

### FIELD OF INVENTION

This invention relates generally to systems and methods for fluid-powered energy conversion devices that utilize the energy of wind or motile fluid to create electrical energy and more specifically to wind turbines.

### BACKGROUND OF THE INVENTION

The power of wind can be expressed mathematically by the equation: P=0.5ρAv³ where

ρ=air density

A=Rotor swept area, ft²

v=wind speed

Wind power is thus proportional to the cube of the wind speed. As a result, the power output at higher wind speeds is significantly higher than at low speed. In a typical prior art wind turbine, the generator is sized to optimally produce electricity at a wind speed of 12-17 meters per second (“m/s”). However, average wind speeds are usually between 4.5-6.5 m/s, depending on the location. A real world example of the variance in wind speeds in a single location is shown in FIG. 1. This figure is a graph of measured wind speeds taken in August 2017 at Schiphol Airport in Amsterdam, The Netherlands.

Utilizing the real world values in the above power equation indicates that the power output at 12 m/s is about 18 times higher than the power output at 4.5 m/s and about 6 times higher than the power output at 6.5 m/s. The discrepancy in power output is significant for at least two reasons. First, significantly more power can be generated in one location by capturing higher speed winds. Second, because usual wind speeds are below those for which a wind turbine is optimally configured, the prior art wind turbine generator often operates at far below its peak output capability.

Maximum power extractable by a turbine from wind is a function of rotor blade tip speed. Optimal tip speed to power ratio is different for each turbine design. The efficiency of a turbine is a function of the tip-speed ratio and the pitch angle of the rotor blades. The pitch angle (often just referred to as the “pitch”) of a blade represents the angle of incidence of wind into the blade face (the blade pitch). The prior art wind turbine generally has four phases of operation. The first phase is intended to control the turbine in low winds—below those of turbine operation. In this first phase the wind does not produce rotor movement and the turbine is not producing power.

The second phase controls the turbine operation when wind speed flows between the level needed to start turbine operation and the speed at which maximum power can be safely and efficiently produced based upon the turbine components. During this phase, the goal is to maximize energy capture per specific wind speed and thus modulation of turbine components and parameters is critical to maximize turbine efficiency. The third phase controls the turbine at wind speeds above the turbine rated wind speed to the wind speed at which the turbine is stopped to prevent damage. In this phase the turbine operation is modulated to limit energy capture and dynamic loads so as not to damage the generator and other turbine components. Energy capture, at least for utility scale turbines, is primarily controlled by modulating pitch of the rotor blades. Modulating blade pitch affects the amount of aerodynamic power captured from the wind. Being an elongate structure, each rotor blade has a longitudinal axis along which the face of the blade may be rotated. Rotating the blade face about this axis changes the angle of incidence of wind into the blade face (the blade pitch), thereby modulating the aerodynamic efficiency of the rotor. In smaller wind turbines, energy capture is controlled with a diversion load located in the inverter, which burns off excess energy captured at wind speeds higher than those that the generator and inverter ratings allow. The fourth phase of wind turbine operation controls the turbine at wind speeds above the speed at which the turbine is stopped to prevent damage. In this phase, the turbine can be stopped either with a brake, by altering the blade pitch angles, or by turning the rotor away from the dominant wind direction.

The typical prior art wind turbine includes a three-bladed assembly to capture wind energy to produce a rotational energy in a rotor. The rotor is axially connected to a generator via a shaft. The generator converts mechanical energy to electrical energy and either feeds this electrical energy directly to the grid or to an inverter to condition the power before sending it to the grid. The efficiency of the turbine is a factor of the efficiencies of gearboxes and support structures utilized in the drivetrain, the generator, the inverter, and the amount of energy that can be extracted from the wind. The rotor can be directly or indirectly connected to the generator via a gearbox installed between the rotor and generator. Gearboxes are often used in utility scale wind turbines to increase the speed of the generator which allows for a lower cost generator.

Wind turbines can be designed to run at a constant speed or at variable speed. Fixed pitch wind turbines designed to operate at constant speed obtain their highest aerodynamic efficiency only at one specific wind speed. Only at this specific wind speed is the optimal tip speed ratio (ratio between the tangential speed of the tip of a blade and the actual speed of the wind) obtained. At other wind speeds, the turbine may not be so efficient. On the other hand, with a variable speed wind turbine, it is possible to run the turbine at optimal tip speed ratios for a variety of wind speeds. Additionally, to improve the energy capturing ability of wind turbines and smooth out the generator output, it is known to include a continuously variable transmission (CVT) either as part of or in conjunction with the gearbox noted above. The CVT is mechanically interposed between the rotor and generator.

It is also known to include as part of the prior art turbine, a flywheel for energy storage. The flywheel is not included as part of the pre-generator portion of the drivetrain, but is instead typically electrically coupled to the generator so as to receive some portion of the generator electrical output. Thus, in the prior art turbine, the flywheel can often be found housed within the windings of the generator such that its mechanical energy may be harvested to produce electricity. In non-utility scale wind turbines, it is known to include an inverter coupled to the generator to receive the electrical output and convert it to a form compatible with the electrical grid. The wind turbine known in the prior art utilizes a generator and inverter that are designed in size in terms of the maximum expected power of wind to be handled. However, one deficit of the prior art turbine is that the generator and power electronics components are often a large cost of the wind turbine. For example, in small wind systems the power electronics are often half the cost of a turbine device. There is thus a need in the art to more economically deliver electricity to a grid from a small wind turbine.

### SUMMARY OF THE INVENTION

The present invention is directed to improved wind turbine drivetrain systems and methods of controlling same that allow the turbine to better store energy from faster wind speeds and that allow the generator and inverter to be sized down significantly, as much as eight times smaller, than the size currently needed to generate maximum power from peak wind. In contrast to the prior art, the present invention drivetrain systems utilize a mechanical arrangement in which a flywheel is placed intermediately between the wind turbine rotor and the generator. The enhanced embodiments of the invention encompass drivetrain systems: a) utilizing CVT control, with and without blade pitch control; and b) a system utilizing blade pitch control without CVT control. The inventive systems reduce the cost of components needed to convert mechanical power from the wind to usable electric power. Because wind speeds fluctuate, the novel intermediate storage of energy from higher power wind can allow the generator to be sized closer to the average power output.

In a first embodiment the invention is directed to a drivetrain system for a wind turbine. The system includes a rotor comprising a plurality of blades connected to a hub; a continuously variable transmission (CVT), a flywheel and a generator. The rotor has a rotor speed and outputs a rotor-outputted rotational energy. The rotor is coupled to the CVT by a first mechanical coupling that transfers the rotor-outputted rotational energy from the rotor to the CVT. The CVT has a CVT ratio and outputs a CVT-outputted rotational energy. The rotor is coupled to the flywheel by a second mechanical coupling that transfers the CVT-outputted rotational energy to the flywheel. The flywheel has a flywheel speed and outputs a flywheel-outputted rotational energy. The flywheel is coupled to the generator by a third mechanical coupling that transfers the flywheel-outputted rotational energy to the generator. The generator produces a generator energy output based on the flywheel-outputted rotational energy received from the third mechanical coupling.

The first embodiment system can be enhanced in several ways all of which can be utilized in additive or alternative fashion with each other. For example, the first embodiment system more preferably includes a controller providing control over the CVT, the flywheel and the generator. The system utilizes CVT modulation as the primary means of optimizing drivetrain efficiency. In this respect, a preferred embodiment of the first embodiment system includes a computerized controller (processor) in electrical communication with the CVT, the flywheel and generator. The controller modulates one or more of the CVT ratio and the generator energy output. Preferably, the controller modulates one or more of the CVT ratio and the generator energy output based upon signals received from one or more sensors. The one or more sensors are preferably selected from the group consisting of a wind speed sensor, a rotor speed sensor, a flywheel speed sensor and a generator output sensor. The system may include other sensor inputs as well as data inputs to control system components to provide optimized efficiency. In this respect, the wind turbine has a determined optimal efficiency tip speed ratio. The wind turbine when operating has an operating tip speed ratio. The controller can modulate one or more of the CVT ratio and the generator energy output in furtherance of having the operating tip speed ratio equal or approach the determined optimal efficiency tip speed ratio.

An enhanced alternate embodiment of the first embodiment system can include blade pitch control modulation to further modulate the system to achieve optimal efficiency. In this enhanced embodiment, one or more of the plurality of blades have an orientation relative to the hub. The system includes a blade pitch control mechanism that alters the orientation of the one or more of the plurality of blades. The controller is in electrical communication with the blade pitch control mechanism and outputs a signal that causes the blade pitch control mechanism to alter the orientation of one or more of the plurality of blades. The blade pitch modulation is preferably done in response to sensor and data inputs indicative of weather conditions, the condition of one or more system components or predictive factors, such as grid user demand. In one enhancement, the first mechanical coupling between the rotor and the CVT includes or is connected to a gearbox. Similarly, the system can include a gearbox as part of the second mechanical coupling between the CVT and the flywheel. The third mechanical coupling between the flywheel and the generator may include or be connected to a gearbox. In any version of the first embodiment drivetrain system, the first electrical output of the generator can be directly or indirectly transmitted to an inverter, a battery or both.

A second embodiment of the inventive drivetrain system is directed to utilizing blade pitch control as the primary method to achieve turbine efficiency. In this second embodiment, a wind turbine system comprises a rotor comprising a plurality of blades connected to a hub. The one or more of the plurality of blades have an orientation relative to the hub. The system includes a blade pitch control mechanism. The blade pitch control mechanism alters the orientation of the one or more of the plurality of blades. The system has a flywheel and a generator. The rotor has a rotor-outputted rotational energy and is coupled to the flywheel by a first mechanical coupling that transfers the rotor-outputted rotational energy of the rotor to the flywheel. The flywheel outputs a flywheel-outputted rotational energy and is coupled to the generator by a second mechanical coupling that transfers the flywheel-outputted rotational energy to the generator. The generator produces a generator energy output based upon the flywheel-outputted rotational energy received from the first mechanical coupling. In contrast to the prior art, the flywheel is placed in functional arrangement before the generator. Either or both of the first mechanical coupling and second mechanical coupling can include or be connected to a gearbox.

As in the case of the first embodiment system, the second embodiment system can be enhanced through implementation of a controller. In this respect, the controller is in electrical communication with the blade pitch control mechanism, the flywheel and the generator. The controller outputs a signal that causes the modulation of one or more of the orientation of the one or more of the plurality of blades and the generator energy output. Preferably, the controller modulates one or more of the orientation of the one or more of the plurality of blades and the generator energy output based upon signals indicative of one or more data elements. The one or more data elements are preferably selected from the group consisting of a blade pitch angle data element, a wind speed data element, a flywheel speed data element and a generator output data element. Data elements may be supplied as sensor inputs or data inputs.

The system's wind turbine has a determined optimal efficiency tip speed ratio. The wind turbine when operating has an operating tip speed ratio. The controller can modulate one or more of the orientation of the one or more of the plurality of blades and the generator energy output in furtherance of having the operating tip speed ratio equal or approach the determined optimal efficiency tip speed ratio. The controller outputs a signal that causes the blade pitch control mechanism to modulate the orientation of one or more of the plurality of blades based upon the controller receiving: a) signals from the blade pitch sensor and the flywheel speed sensor; and b) data indicating current wind speed data. The second embodiment system can include a CVT, including one controllable by the controller, but it is an optional component.

Either embodiment system can be enhanced such that the controller transmits a signal to the generator that causes the generator to alter the generator energy output. Either embodiment system can have an inverter that directly or indirectly receives the first electrical output of the generator. The inverter produces an electrical output based upon the first electrical output from the generator. The controller is in electric communication with the inverter, preferably through inverter power control system electronics that may be a separate module or part of the controller. The controller or inverter power control system can transmit a signal to the inverter that causes the inverter to adjust the second electrical output. The embodiment systems can include a brake operative with the generator or rotor brake that when actuated alters the application of a braking force on the rotor or other system component such as the flywheel or generator, so as to modulate the rotational energy of the rotor. In the case of a rotor brake, the controller is in electrical communication with the brake and transmits a signal to the brake that causes the rotor brake to alter a braking force on the rotor. The inventive systems may be deployed to supply electricity to a specific building and may be integrated with an electricity supply system that includes a solar energy component.

### BRIEF DESCRIPTION OF THE DRAWINGS

FIG. 1 is graph showing the durations of wind speed levels over the course of a sample day in August 2017 at Amsterdam Schiphol Airport. Speeds were measured at 30-60 minute intervals.

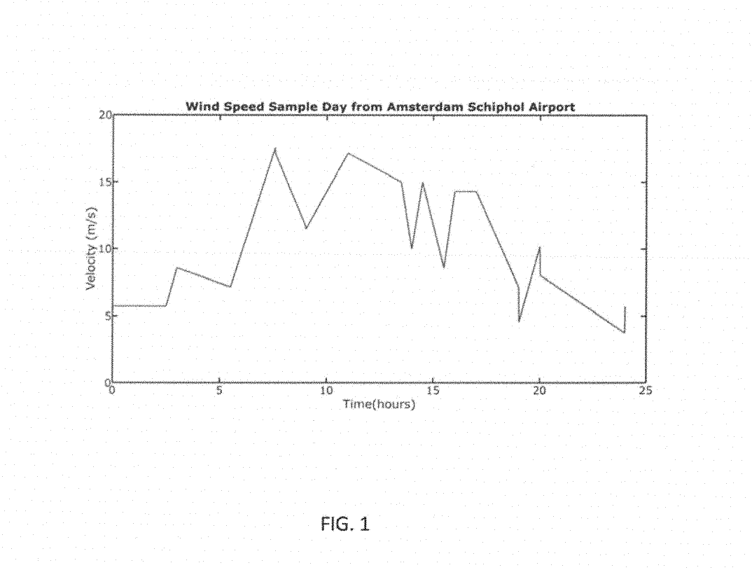

FIG. 2 is a graph showing estimated power output, flywheel energy storage and total power extracted from a turbine on a high wind speed day in Amsterdam.

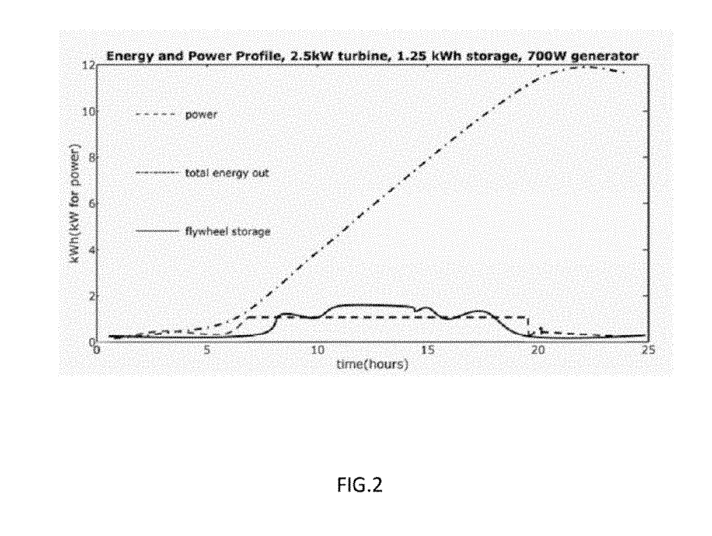

FIG. 3 is a graph that shows the relationship of tip-speed ratio to power coefficient (efficiency).

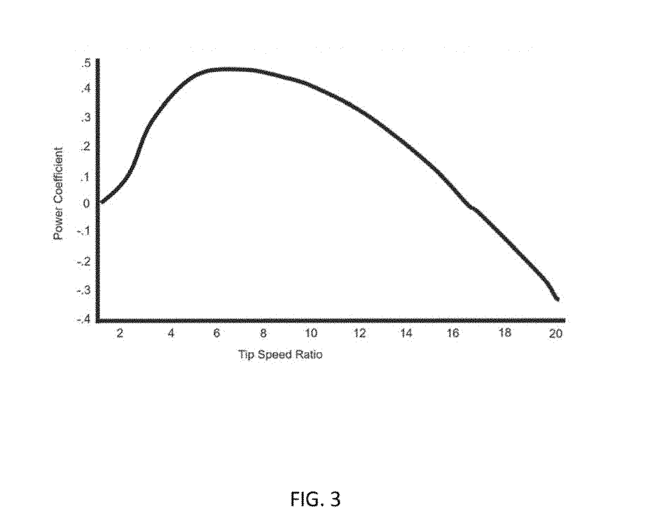

FIG. 4 is a block diagram showing a first embodiment of a present invention turbine drivetrain system utilizing CVT control as the primary method of drivetrain modulation. First embodiment system includes a controller controlling a CVT disposed between the turbine rotor and a flywheel preceding a generator.

FIG. 5 is a block diagram showing a second embodiment of a present invention turbine drivetrain system utilizing blade pitch control as the primary method of drivetrain modulation. Second embodiment system includes a controller controlling a blade pitch control mechanism and a flywheel interposed between the rotor and a generator.

FIG. 6 shows how the CVT and blade pitch control mechanisms of the first and second embodiment drivetrain systems may be incorporated in a horizontal axis wind turbine. Removal of the CVT component from FIG. 6 reflects a second embodiment system.

FIG. 7 shows how the CVT and blade pitch control mechanisms of the first and second embodiment drivetrain systems may be incorporated in a vertical axis wind turbine. Removal of the CVT component from FIG. 7 reflects a second embodiment system.

FIG. 8 is a block diagram showing how in one embodiment application the present invention turbine systems can be adjoined to an electricity supply system that includes a solar energy component.

FIG. 9 is a block diagram showing how in another embodiment application the present invention turbine systems can be adjoined to an electricity supply system that includes a solar energy component and a battery.

FIG. 10 is block diagram showing how a plurality of the present invention turbine systems can be utilized to create an electricity supply system.

FIG. 11 is a flowchart depicting a preferred embodiment control logic (method) for the described first embodiment system utilizing CVT control as the primary method of drivetrain modulation and describes how the CVT and generator output energy/flywheel speed can be controlled to optimize turbine performance.

FIG. 12 is a flowchart depicting the normal flywheel control scheme (method) for the described first embodiment drivetrain system using the control logic depicted in FIG. 11.

FIG. 13 is a flowchart depicting a preferred embodiment control logic (method) for the described second embodiment system utilizing blade pitch control as the primary method of drivetrain modulation and describes how the blade pitch control mechanism and generator output energy/flywheel speed can be controlled to optimize turbine performance.

FIG. 14 is a flowchart depicting the normal flywheel control scheme (method) for the described second embodiment drivetrain system using the control logic depicted in FIG. 13.

FIG. 15 is a chart showing how the CVT and flywheel are utilized to optimize drivetrain efficiency in the first embodiment system.

### DETAILED DESCRIPTION

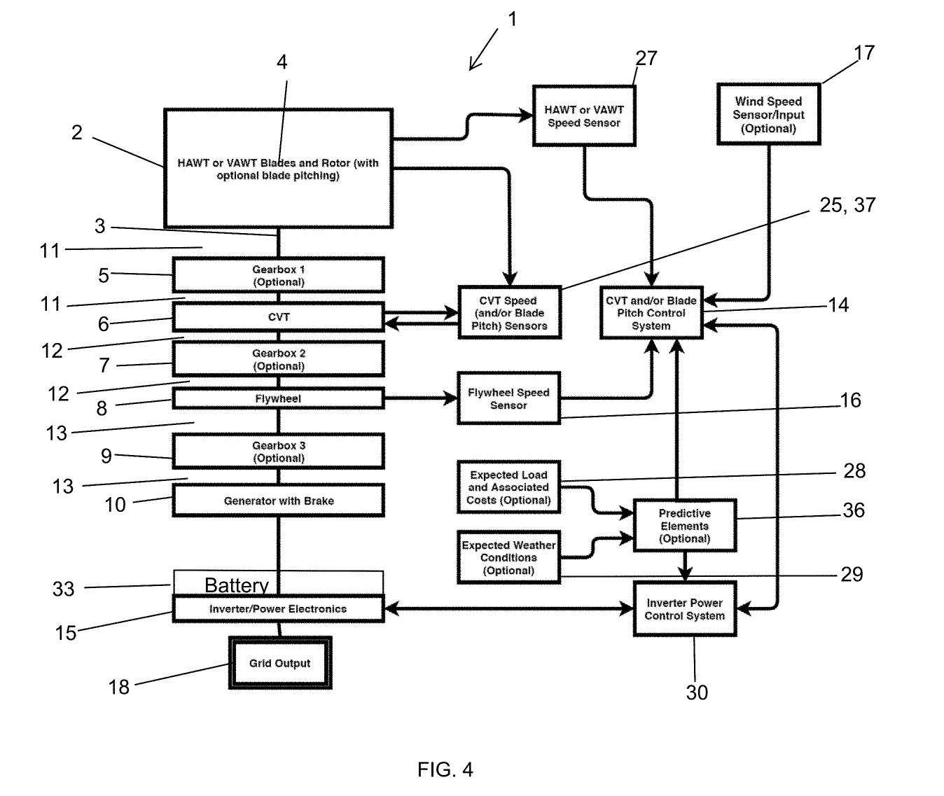

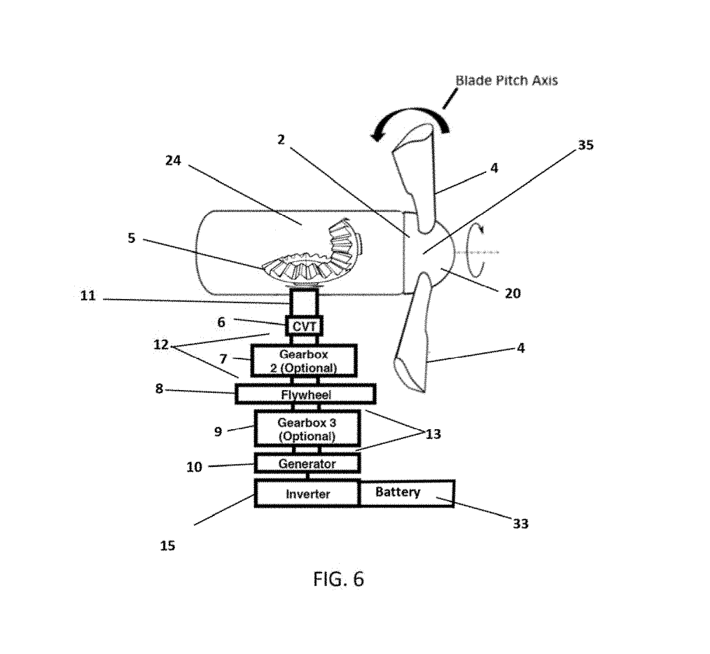

Embodiments of the present invention wind turbine drivetrain systems shall now be described in reference to the figures. FIG. 4 shows a first embodiment of a present invention turbine drivetrain system 1 having preferred embodiment features. As shown in the figures, drivetrain 1 comprises a rotor 2 having a shaft 3 that is connected (mechanically coupled) to hub 35 holding a plurality of blades 4. This connection is representatively shown in FIG. 6 by gearing 23. By virtue of its connection to blades 4, shaft 3 has a rotor rotational energy. (In the case where blades 4 are static the rotor rotational energy level would be zero.) The embodiment inventive system further includes a continuously variable transmission (CVT) 6, a flywheel 8 and a generator 10.

The mechanical arrangement of first embodiment system 1 shall now be discussed. Rotor 2 is coupled (via hub 35 and shaft 3) to CVT 6 by a first mechanical coupling 11 that transfers the rotational energy of rotor 3 to CVT 6. First mechanical coupling 11 may be any type of mechanical or system linkage known in the prior art. CVT 6 has a controllable CVT ratio. Based upon this input rotational energy from rotor 2 CVT 6 outputs a CVT-modulated (a/k/a CVT-outputted) rotational energy. CVT 6 is coupled to flywheel 8 by a second mechanical coupling 12 that transfers the CVT-modulated rotational energy to flywheel 8. Second mechanical coupling 12 may be any type of mechanical or system linkage known in the prior art. Flywheel 8 outputs a flywheel-modulated rotational energy. Flywheel 8 is coupled to generator 10 by third mechanical coupling 13 that transfers the flywheel-modulated rotational energy to generator 10. Third mechanical coupling 13 may be any type of mechanical or system linkage known in the prior art. Generator 10 produces an electrical output based upon the rotational energy received from third mechanical coupling 13.

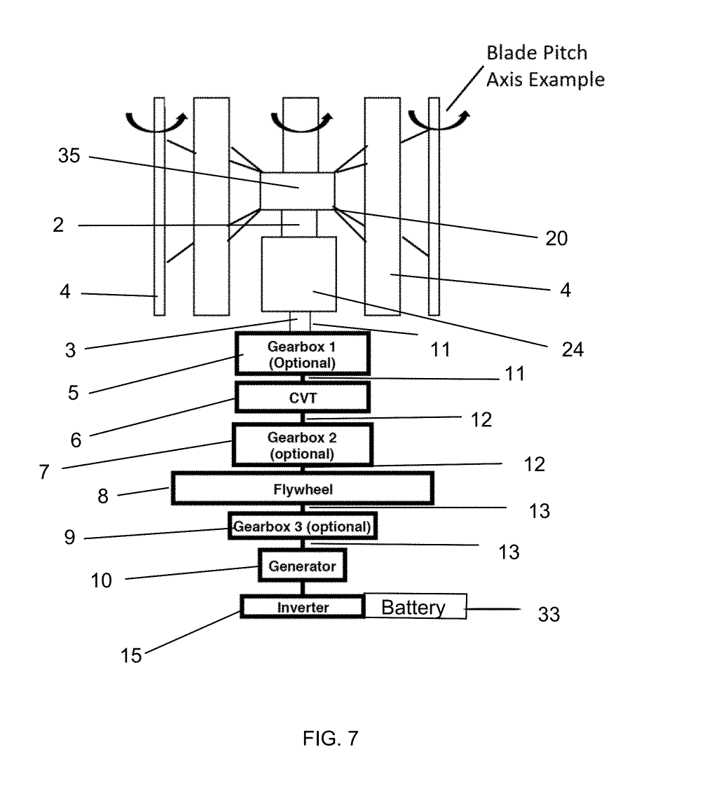

In contrast to prior art drivetrain systems, in the first embodiment system, CVT 6 advantageously delivers rotational energy to a flywheel 8 functionally positioned before generator 10. The inventive drivetrain can be employed with either a Horizontal Axis Wind Turbine (HAWT) or Vertical Axis Wind Turbine (VAWT) that employs a rotor 2 (shown in FIGS. 6 and 7) that comprise a plurality of blades 4 connected to a hub 35 connected to a shaft 3. By way of general description, rotor 2 is coupled to flywheel 8 through CVT 6 in order to decouple the speed of the rotor 2 from that of flywheel 8. As used herein, unless otherwise stated, the terms “connect,” “connected,” “couple,” “coupled” and the like encompass direct and indirect connection apparatus and techniques.

Generator 10 of system 1 produces a generator energy output based upon the flywheel-outputted rotational energy received from third mechanical coupling 13. It is preferable that generator energy output of generator 10 be delivered to inverter 15 for grid output/distribution to grid 18. Flywheel 8 may comprise a low-efficiency flywheel which does not operate in a vacuum to reduce flywheel drag or a higher efficiency flywheel which may use a vacuum, magnetic bearings, or other mechanisms to increase overall flywheel storage efficiency. Flywheel 8 may include and be driven primarily by use of a metal rotor portion, a composite rotor portion or a flywheel which includes moving fluids as a mechanism for flywheel control. Flywheel 8 may comprise a low mass and high speed to achieve needed storage capacity or a high mass and low speed to the same end, or at somewhere in between. Flywheel 8 may operate at a more constant speed and varies the rotor distance in order to control the total amount of energy storage. First, second and third mechanical couplings 11, 12, 13 may be any type of mechanical coupling known in the prior art. Exemplary first, second and third mechanical couplings include fixed speed gearboxes, a shaft connection (e.g., beam coupling, bellows coupling, chain coupling, jaw coupling, diaphragm coupling, disc coupling, grid coupling, Oldham coupling, Schmidt coupling, clamping coupling, meshing tooth coupling, Hines coupling, pin and bush coupling and spline coupling) or a shifting gearbox. As is revealed by the above description and the figures, and in contrast to the prior art, CVT 6 is placed between rotor 2 and flywheel 8, which precedes generator 10 in the drivetrain. CVT 6 is thus used to decouple the speed of rotor 3 from the speed of flywheel 8, which precedes generator 10 in the drivetrain. This allows rotor 2 to operate closer to its optimal tip speed ratio as compared to currently available turbines.

The first embodiment system can be enhanced in several ways all of which can be utilized in additive or alternative fashion with each other. For example, depending on the design parameters and speed ranges of the wind turbine blades 4, CVT 6, flywheel 8 and generator 10, first, second and third mechanical couplings 11, 12 13 may respectively include or connect with gearboxes 5, 7, 9. In this fashion, gearboxes 5, 7, 9 are placed between components to achieve the required system speeds. These gearboxes may either be fixed ratio gearboxes, or gearboxes which change ratio in response to control inputs. In this regard, first mechanical coupling 11 can include or connect with gearbox 5, such that gear box 5 is functionally disposed between rotor 2 and CVT 6. This will allow rotor 2 to achieve speeds required for higher speed flywheel operation. Gearbox 5 is preferably a fixed speed gearbox, but may also be a shifting gearbox in order to allow possible ratios between the rotational speed of rotor 2 and that of flywheel 8. In another version, first embodiment drivetrain 1 can be revised such that second mechanical coupling 12 includes or connects with gearbox 7 functionally located between CVT 6 and flywheel 8. Similarly, third mechanical coupling 13 can include or connect with gearbox 9 functionally located between flywheel 8 and generator 10. Gearboxes 7 and 9 can be fixed speed gearboxes or shifting gearboxes depending upon desired features.

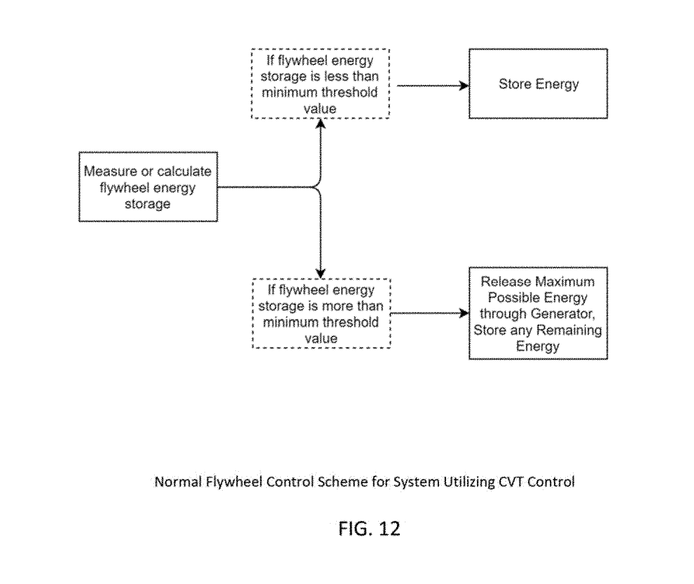

The first embodiment system is preferably enhanced to include controller 14 in electrical communication with one or more of the CVT 6, flywheel 8 and generator 10. Controller 14 desirably modulates one or more of the CVT ratio and the generator energy output, preferably based upon data elements received in the form of signals received from one or more sensors or as user data inputs. In a preferred embodiment, controller 14 communicates with either or both of the inverter 15 and battery 33. As used in this application terms referencing communication or electrical communication with the controller or between components include wireless, electronic and electrical forms of communication. Controller 14 will send a signal to inverter 15 or battery 33 to create an electrical load which will change the energy stored in flywheel 8 and in generator 10. In this respect, preferred sensors include a wind speed sensor 17, a rotor speed sensor 27, a flywheel sensor 16 and a generator output sensor 38. It is preferred that system 1 have at least a wind speed sensor 17, a rotor speed sensor 27, and a flywheel sensor 16 so that it may calculate an operating tip speed ratio for the system along with a measure of the energy stored in the flywheel. With reference to the operating tip speed ratio, a wind turbine has a determined optimal efficiency tip speed ratio. The wind turbine when operating has an operating tip speed ratio. Thus, to optimize efficiency, in one embodiment application the controller will modulate one or more of the CVT ratio and the generator energy output in furtherance of having the operating tip speed ratio equal or approach the determined optimal efficiency tip speed ratio. System control is governed by computerized controller 14, which is in electrical communication with one or more of the CVT 6, flywheel 8, and generator 10. During normal operation controller 14 preferably exercises superintendent control over flywheel 8 in accordance with a normal flywheel control scheme depicted in FIG. 12. Controller 14 is thus in direct or indirect electrical communication with flywheel 8. Indirect electrical communication with the flywheel may include indirect flywheel control by sending a control signal to a generator, battery, rectifier-inverter, or electrical inverter. Flywheel 8 stores or releases energy based upon a signal from controller 14, which may be sent to the flywheel through indirect or direct communication. This superintendent control is augmented in the inventive system having the novel placement of CVT and flywheel in the drivetrain through a feedback system regulating the CVT ratio of CVT 6. More specifically, CVT 6 has an adjustable CVT ratio enabling CVT 6 to output rotational energy. The CVT ratio may be controlled by a signal from controller 14.

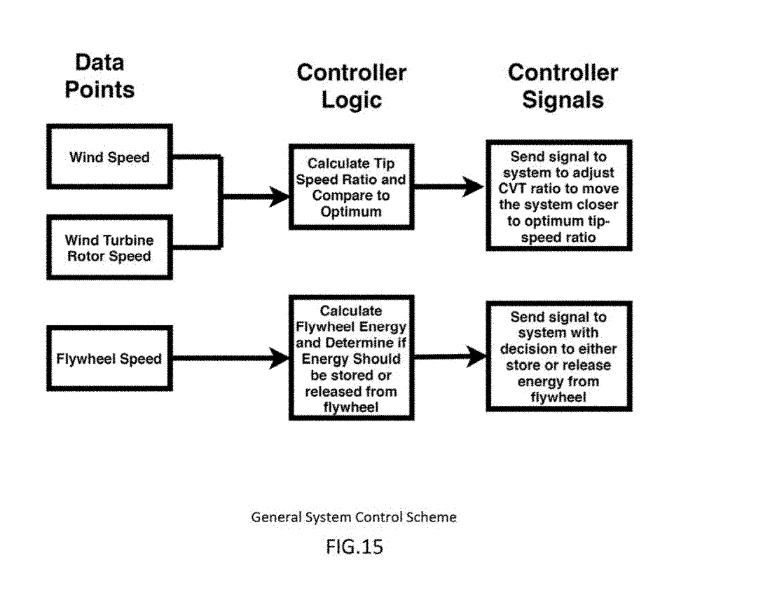

As noted, the operation of the first embodiment system is enhanced by utilization of controller 14. Preferred operational techniques utilizing controller 14 are now described relative to the enhanced first embodiment system, which has a general control scheme reflected in FIG. 15 and a more specific flywheel control scheme shown in FIG. 12. In this respect, controller 14 is in electrical communication with CVT 6 and flywheel 8. (In the case of flywheel 8, this communication may be established through generator 10, battery, inverter-rectifier, or electrical inverter.) This electrical communication allows for two key control points: the CVT ratio and whether energy is being stored or released from the flywheel. Controller 14 preferably modulates one or more of the CVT ratio and the flywheel energy storage based upon one or more data elements received by the controller in the form of a sensor input or data input. The one or more data elements are preferably selected from the group consisting of a wind speed data element, a rotor speed data element, a flywheel speed data element and a generator output data element. CVT sensor 25 is in electrical communication with controller 14. CVT sensor 25 measures a condition of CVT 6 (such as, but not limited to, CVT ratio) and outputs a signal based upon that measurement. Wind turbine rotor speed sensor 27 is also in electrical communication with controller 14. Wind turbine rotor speed sensor 27 measures speed of rotor 2 and outputs a signal based upon that measurement.

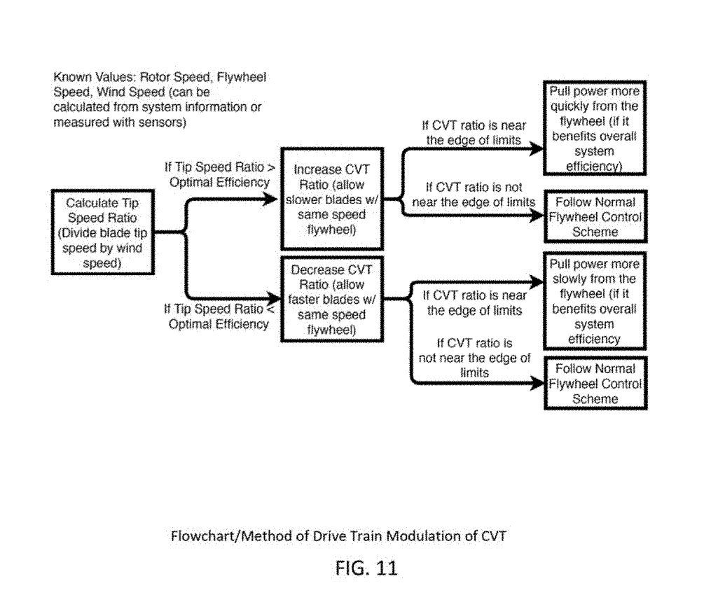

Flywheel speed sensor 16 is in electrical communication with controller 14. Flywheel speed sensor 16 measures speed of flywheel 8 and outputs a signal based upon that measurement. Controller 14 thus modulates CVT 6 based upon three main data elements: wind turbine rotor speed, flywheel speed and current wind speed. Wind turbine rotor speed and flywheel speed may be measured directly by sensors 16, 27 and thereby be provided as data element inputs to controller 14 in that fashion. Alternatively, if controller 14 has only one of the flywheel speed and wind turbine rotor speed data elements, the other one may be derived based upon feedback from the CVT sensor 25. The wind speed data provided to controller 14 may be in the form of a signal from a wind speed sensor 17 or can be a calculated data input generated based upon other system data. Thus, based upon controller 14 receiving: a) two or more of the signals from the CVT sensor, the wind turbine rotor speed sensor or the flywheel speed sensor; and b) current wind speed data, controller 14 outputs a signal that causes CVT 6 to modulate the CVT-outputted rotational energy. If controller 14 determines that further adjustments are needed to the system but that CVT 6 should not or cannot be further modulated because the CVT has reached or is approaching its modulation limits, controller 14 outputs a signal that causes flywheel 8 to modulate the flywheel-outputted rotational energy. The basic control logic of the first embodiment system over CVT 6 and flywheel 8 is shown in FIGS. 11, 12 and 15.

The control system of first embodiment drivetrain system 1 will thus be used to control the power out of the system and CVT ratio based on one or more of the following parameters:current flywheel state, current/predicted wind speeds and predicted power demand parameters. A primary goal of this control scheme is to achieve a maximum tip-speed ratio for energy efficiency. Additional optional processor inputs for enhanced system performance could include signals based upon expected weather conditions, expected load or costs associated with system operation. For example, in the case where system 1 is electrically connected to a grid 18 that provides electricity to consumers, predicted consumer demand could be a data input element that results in processor 14 sending operational control signals to CVT 6 or flywheel 8. In this respect, consumers have an electrical usage demand that can be predicted and used to modulate drivetrain system performance. The signal outputted by the controller that causes the CVT 6 to modulate the CVT-outputted rotational energy and flywheel 8 to modulate the flywheel-outputted rotational energy can also be based upon the controller receiving data concerning the predicted electrical usage demand of the consumers.

The control scheme of the first embodiment system also represents an inventive method of turbine drivetrain control, which is more particularly described and shown in FIGS. 11, 12 and 15. In this respect, FIG. 11 is a flowchart depicting the control logic for the described first embodiment system and describes how the CVT and flywheel can be modulated to optimize turbine performance. FIG. 12 is a flowchart depicting the normal flywheel control scheme for the described first embodiment drivetrain system under the control logic depicted in FIG. 11. FIG. 15 is a chart showing how the CVT and flywheel are utilized to optimize drivetrain efficiency in the first embodiment system. The main goal of the system control is to maximize efficiency of the overall drive train operation, while maintaining system reliability. One of the main advantages that the inventive system and method has compared to other drivetrains, is that it can operate closer to an optimal tip-speed ratio at more than one wind speed. As shown in FIGS. 11 and 12, as a result of receiving the described data elements and input, controller 14 outputs a signal that causes CVT 6 to modulate its CVT-outputted rotational energy. After controller 14 outputs a signal that causes CVT 6 to modulate the CVT-outputted rotational energy, if controller 14 determines that further modulation is necessary and/or that CVT 6 is at or near operational limits, controller 14 outputs a signal that causes generator 10 to modulate the generator output energy effectively by causing flywheel 8 to modulate the flywheel outputted rotational energy.

To achieve this operational advantage certain information must be known. In this respect, three data elements must be known: a) current wind speed; b) wind turbine rotor speed; and c) flywheel speed. As for current wind speed, this data element may be estimated, supplied via wind speed sensor 17 or determined based upon system performance. As for wind turbine rotor speed and flywheel speed, these two data requirements can be sensed directly or can be derived when any two of the following data elements are known: wind turbine rotor speed, CVT ratio and flywheel speed. Any two of these together give the needed information for system control. Having this information permits control over the CVT ratio and whether flywheel is storing or releasing energy. The depicted control scheme, as described, may be modified to control the CVT and flywheel energy storage based on requirements of other parameters such as: system-level efficiency concerns (operating at high efficiency points in the CVT, gearbox, generator, inverter to maximize overall system-level efficiency); system-level reliability concerns (component response time concerns to require long-term reliable system operation); predicted weather conditions such as wind speeds and current or predicted electricity demand.

As compared to the prior art, the inventive drive train includes a CVT as part of the turbine drivetrain in advance of the flywheel functionally located before the generator. By constructing the drivetrain in this fashion, reduction of costs associated with the generator and power conversion electronics is achieved by taking advantage of the mechanical linkage of the flywheel to the rotor via the CVT. With this structure, the drivetrain can draw broadly similar amounts of energy out of the wind as would be achieved with a more expensive generator and power electronics package.

As shown in FIGS. 4, 6 and 7, inventive drivetrain system 1 may be modified so that modulation of the pitch of blades 4 may also be used in conjunction with modulation of CVT 6. The modulation of blade pitching can help achieve ideal tip-speed ratio or be used as a braking mechanism to slow the blades down in high wind speed scenarios. As discussed above, each blade 4 has an orientation relative to hub 35. This orientation is referred to as blade pitch and can be used to modulate the performance of a turbine. To take advantage of this modulation ability, system 1 may include a blade pitch control mechanism 20 that causes the orientation of one or more of the plurality of blades. In FIGS. 6 and 7 the rotational lines around blades 4 shows how blade pitching would be achieved on a horizontal axis wind turbine and on a vertical axis wind turbine. Blade pitch control mechanisms are known in the art. The typical blade pitch control mechanism is mechanically connected to the turbine blades such that upon mechanical or electrical actuation the mechanical connection with the blades is driven and causes the blades to rotate and redirect the angle of the blade faces.

With the first embodiment drivetrain system 1 with blade pitch control, controller 14 will output a signal that will cause blade pitch control mechanism 20 to alter the orientation of one or more blades 4. This signal output can be based upon any of the sensor signals or data elements explained above and also would require a sensor 37 or data element signal indicating blade pitch angle. By way of example and not limitation, controller 14 receives the signal or signals emitted by at least one of sensors 16, 25, 27. Controller 14 is in electrical communication with blade pitch control mechanism 20. In response to the determination of flywheel speed and wind turbine rotor speed from signals received from at least two of sensors 16, 25, 27, controller 14 transmits a signal to blade pitch control mechanism 20 that causes blade pitch control mechanism 20 to change the orientation of the one or more of the plurality of blades 4. Controller 14 can output similar blade pitch modulating signals based upon the data elements shown in FIG. 4. Changing blade pitch is particularly useful in modulating the speed of the rotor 2 based upon wind speed conditions. Blade pitch modulation system 20 can thus dynamically change blade pitch in order to achieve a more optimal tip speed ratio.

As a general rule for embodiment system 1 with blade pitch control, the CVT will be used as a faster controller (over the blade pitch control), used to adjust to the optimal tip speed more quickly. If the tip-speed ratio is faster than desired, the CVT will increase its gear ratio in order to reduce the tip-speed ratio while maintaining flywheel speed. As the edge of the CVT range is reached, if the tip-speed ratio is still faster than desired, then power will be pulled more quickly from the flywheel in order to reduce the tip-speed ratio further. This power control point is critical. If the tip-speed ratio is slower than desired, the CVT will decrease its gear ratio in order to increase the tip-speed ratio while allowing the flywheel to operate at its current speed. As the edge of the CVT range is reached in this scenario, less power will be removed from the flywheel in order to charge it faster and increase the overall flywheel speed. Flywheel efficiency will also be taken into account in these calculations. Unless other inputs, such as predicted wind speeds or predicted power demand parameters, show that it is more efficient or cost effective to store power, as a general rule power will be removed from the flywheel as quickly as possible in order to maintain additional storage capacity and reduce efficiency losses.

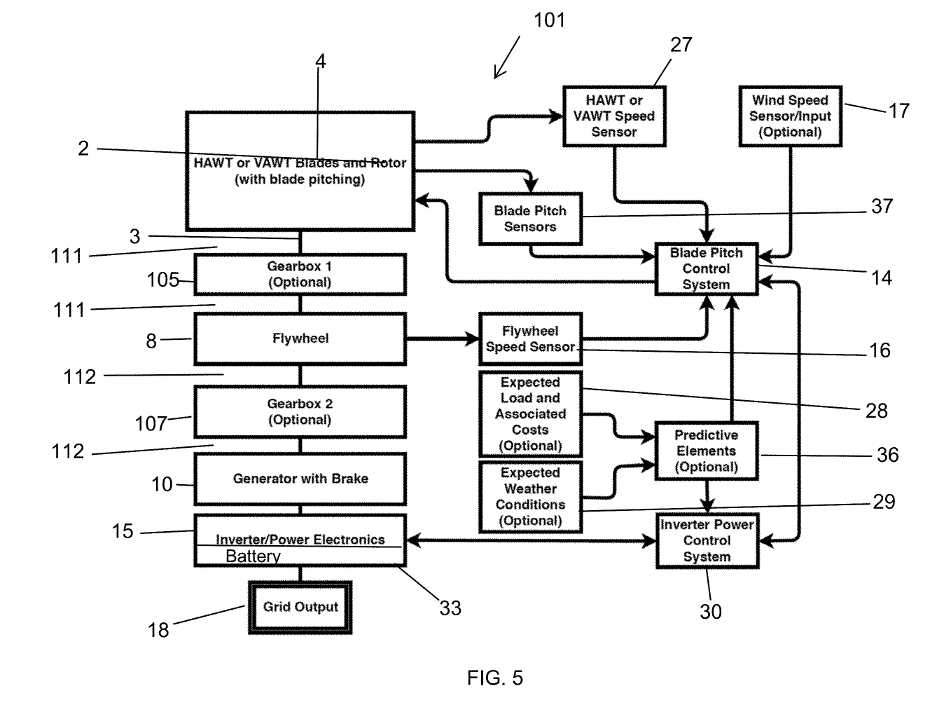

The invention is also directed to a second embodiment wind turbine system 101 as is depicted in FIG. 5 that can also be deployed on the exemplary horizontal axis wind turbine of FIG. 6 and the vertical axis wind turbine of FIG. 7 sans the CVT and CVT sensor. Second embodiment drivetrain system 101 utilizes blade pitch control as the primary method to achieve turbine efficiency. More particularly, a CVT is not included in the drive train, and blade pitching is used to increase efficiency of the system. (A CVT can be included as an option.) Thus, blade pitching is used instead of a CVT to create a fast response controller. Achieving optimal tip speed ratio is thereby made via changes to the pitch of the blades. Therefore, if the speed is constrained by the connection between the flywheel and the rotor, the blades can dynamically change pitch in order to achieve a more optimal tip speed ratio. This configuration works very similarly to the above-described embodiment system 1 that includes a CVT, with the exception that control inputs of CVT ratio are removed.

The second embodiment wind turbine system 101 comprises a rotor 2 comprising a plurality of blades 4 connected to hub 35. One or more of the plurality of blades 4 have an orientation relative to hub 35. Embodiment system 101 includes blade pitch control mechanism 20 that alters the orientation of the one or more of the plurality of blades 4. Embodiment system 101 also includes flywheel 8 and a generator 10. Rotor 2 has a rotor-outputted rotational energy, delivered via shaft 3. Rotor 2 is coupled to flywheel 6 by a first mechanical coupling 111 that transfers the rotor-outputted rotational energy of rotor 2 to flywheel 8. Flywheel 8 outputs a flywheel-outputted rotational energy and is coupled to generator 10 by second mechanical coupling 112 that transfers the flywheel-outputted rotational energy to generator 10. Generator 10 produces a generator energy output based upon the flywheel-outputted rotational energy received from second mechanical coupling 112. The mechanical couplings explained in reference to first embodiment system 1 can be utilized in the case of system 101.

Second embodiment drivetrain system 101 can be enhanced additively or alternatively to create a more preferred embodiment. Either or both of the first mechanical coupling and second mechanical coupling can include or be connected to a gearbox. Hence, in one enhancement, first mechanical coupling 111 can include or connect with gearbox 105 mechanically coupling rotor 2 to flywheel 8. In another enhancement, second mechanical coupling 112 can include or connect with gearbox 107 mechanically coupling flywheel 8 to generator 10. Note that embodiment system 101 can have a CVT, however, its control is not required for second embodiment system. Rather, the controlled features are blade pitch and whether flywheel is storing or releasing energy

The second embodiment system is preferably enhanced to include controller 14 in electrical communication with one or more of the blade pitch control mechanism 20, flywheel 8 and generator 10. Controller 14 desirably modulates one or more of the orientation of the one or more plurality of blades and the generator energy output, preferably based upon data elements received in the form of signals received from one or more sensors or as user data inputs. The controller modulates one or more of the orientation of the one or more of the plurality of blades and the generator energy output based upon signals indicative of one or more data elements. The generator energy output is modulated based upon modulating the flywheel to release or store energy. The one or more data elements are preferably selected from the group consisting of a wind speed data element, a blade pitch angle data element, a flywheel speed data element and a generator output data element. In a preferred embodiment, controller 14 communicates with either or both of the inverter 15 and battery 33. Controller 14 will send a signal to inverter 15 or battery 33 to create an electrical load which will change the energy stored in flywheel 8 and in generator 10.

System 101 includes controller 14 in electrical communication with one or more of the blade pitch control mechanism 20 and flywheel 8. Blade pitch sensor 37 is in electrical communication with controller 14. Blade pitch sensor 37 measures the orientation (blade pitch angle) of one or more of the plurality of blades 4 and outputs a signal based upon that measurement. The second embodiment system can optionally include wind turbine rotor speed sensor 27 in electrical communication with controller 14, though rotor speed can be determined in the second embodiment system through flywheel speed data. If included, wind turbine rotor speed sensor 27 measures a speed of rotor 2 and outputs a signal based upon that measurement. Flywheel speed sensor 16 is in electrical communication with controller 14. Flywheel speed sensor 16 measures a speed of flywheel 8 and outputs a signal based upon that measurement. In this preferred embodiment system, controller 14 outputs a signal that causes blade pitch control mechanism 20 to modulate the orientation of one or more of the plurality of blades 4 based upon controller 14 receiving: a) the signals from the blade pitch sensor and the flywheel speed sensor; and b) data indicating current wind speed data. Generator 10 produces a generator energy output based upon the flywheel-outputted rotational energy received from second mechanical coupling 112. Generator 10 is preferably electrically coupled to inverter 15 such that inverter 15 receives the electrical output of generator 10 and delivers a second electrical output to grid 18.

The wind turbine for the second embodiment system has a determined optimal efficiency tip speed ratio. The wind turbine when operating has an operating tip speed ratio. Controller 14 modulates one or more of the orientation of the one or more of the plurality of blades, the flywheel speed and the generator energy output in furtherance of having the operating tip speed ratio equal or approach the determined optimal efficiency tip speed ratio. To achieve this, with embodiment system 101 there are two required control points: the blade pitch angle and whether energy is being stored or released from the flywheel. In one embodiment, the flywheel control can be based upon inputs from the inverter control system 30. The goal of inventive drivetrain system embodied by system 101 is to maximize efficiency of the overall drive train operation, while maintaining system reliability. An advantage of this system over the prior art is that it can operate closer to an optimal tip-speed ratio at more than one wind speed. The system requires the following data inputs to achieve its goals: blade pitch angle, flywheel speed and a value for current wind speed. The value for current wind speed may be based upon a direct measure, an estimate or inferred from system behavior.

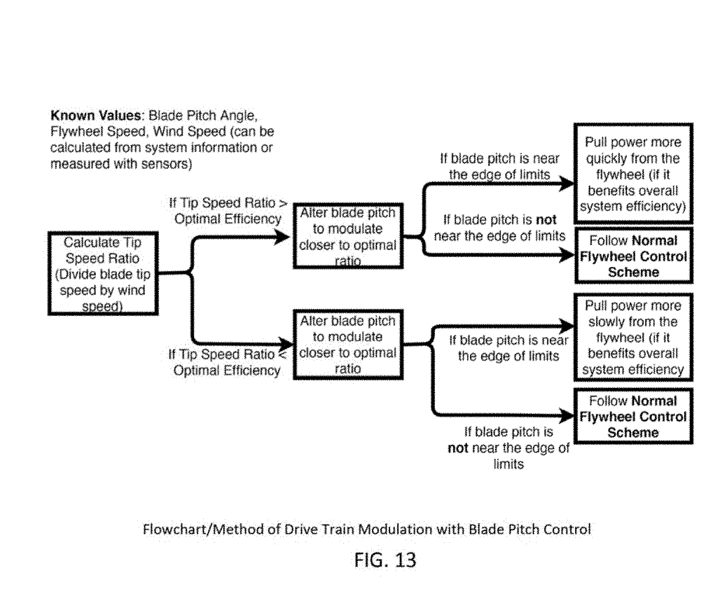

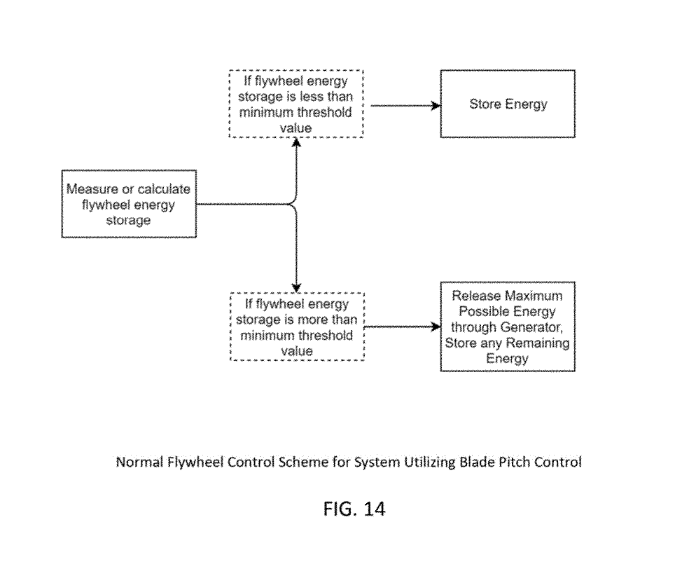

The control scheme of second embodiment system 101 also represents an inventive method of turbine drivetrain control, which is more particularly described and shown in FIGS. 13 and 14. In this respect, FIG. 13 is a flowchart depicting the control logic and steps for the described second embodiment system and describes how the blade pitch control mechanism and flywheel can be modulated to optimize turbine performance. FIG. 14 is a flowchart depicting the normal flywheel control scheme and steps for the described second embodiment drivetrain system using the control logic depicted in FIG. 13. As shown in the figures, as a result of receiving the noted data elements and inputs, the controller outputs a signal that causes the blade pitch control mechanism to alter the orientation of one or more of the plurality of blades. In line with the control scheme shown in the figures, after the controller outputs a signal that causes the blade pitch control mechanism to alter the orientation of one or more of the plurality of blades, the controller outputs a signal that causes the flywheel to modulate the flywheel outputted rotational energy (which modulates the generator output energy) based upon a determination that the blade pitch control mechanism is near operational limits.

As ideal tip-speed ratio changes with blade pitch, the blades will pitch to make the design as efficient as possible at the given rotor speed. In addition to this, an ideal speed will be set for maximum efficiency of the system, and the flywheel will spin up and down by deciding how much power to store and how much to output in order to reach this maximum efficiency. Predictive weather and projected demand inputs will be used in a similar manner to the configuration using a CVT. Blade pitching may also be used to slow down turbine blade speeds when wind speeds are higher than design parameters allow for. In the event that more power needs to be taken out to maintain safe operation, a conventional braking system may be utilized

Features, advantages and applications of first embodiment drivetrain system 1 and second embodiment drivetrain system 101 will now be discussed. The control schemes and methods of either system may be based upon requirements of the following non-exclusive additional parameters: Greater system-level efficiency concerns (operating at high efficiency points in the CVT, gearbox, generator, inverter to maximize overall system-level efficiency), greater system-level reliability concerns (component response time concerns to require long-term reliable system operation), predicted future wind speeds and current or predicted electricity demand. As shown in FIGS. 4 and 5, expected load and associated costs 28 and expected weather conditions 29 represent optional exemplary predictive data elements 36 that can be used as inputs for controller 14 and inverter power control system 30 to modulate systems 1, 101. Also, while the tip-speed ratio control scheme described herein is one very useful embodiment, it is not the only way that a control scheme can be implemented in the embodiment systems. In some instances, it may be advantageous for a system to do things that are counter to achieving the optimal tip speed ratio, such as optimizing for efficiency of other components (generator, inverter, flywheel), or operating in a way that promotes component and system reliability.

Thus, as indicated in FIGS. 4 and 5, the intelligence of controller 14 may be increased by including predictive wind speed data and predicted/current demand data. In the case of predictive wind speed data, if wind speeds are expected to rise, the controller will need to interpret this data based on the amount of storage that will be required to capture the faster speed wind, and the amount of storage capacity remaining in the flywheel in order to decide whether or not to extract power from the flywheel. If short bursts are anticipated, the flywheel may spin up to be at the appropriate wind speeds for maximum tip speed ratio. If longer peaks are anticipated and the flywheel is already storing a considerable amount of energy, the flywheel may have energy drawn out of it more quickly to provide energy storage capacity for the longer peak. These are just a few examples of many ways that predictive wind speed may be used in order to increase the total energy output from the system. Predictive wind speed data may be gathered from the cloud or other wireless communications, or from a co-located source of weather information.

Consumer demand can also be predicted and used as input for the systems. With respect to embodiment drivetrain system 1 the system is connected to a grid providing electricity to consumers. The consumers have an electrical usage demand that can be predicted. The controller can output a signal that causes the CVT to modulate the CVT-outputted rotational energy based upon the controller receiving the predicted electrical usage demand of the consumers. In line with the depicted control scheme, after the controller outputs a signal that causes the CVT to modulate the CVT-outputted rotational energy, the controller outputs a signal that causes the flywheel to modulate the flywheel outputted rotational energy based upon a determination that the CVT is near operational limits. With respect to embodiment drivetrain system 101 the system is likewise connected to a grid providing electricity to consumers who have an electrical usage demand that can be predicted. The controller outputs a signal that causes the blade pitch control mechanism to alter the orientation of one or more of the plurality of blades based upon the controller receiving the predicted electrical usage demand of the consumers. In line with the control scheme shown in the figures, after the controller outputs a signal that causes the blade pitch control mechanism to alter the orientation of one or more of the plurality of blades, the controller outputs a signal that causes the flywheel to modulate the flywheel outputted rotational energy based upon a determination that the blade pitch control mechanism is near operational limits.

FIGS. 6 and 7 demonstrate how embodiment systems 1, 101 can be incorporated into a wind turbine with horizontal axis arrangement and vertical axis arrangement. When a vertical axis wind turbine such as that represented in FIG. 7 is used, the first gearbox 5, 105 is optional as there is no requirement to change the axis of rotation. The axis of rotation of the vertical wind turbine and that of the transmission are more likely to be the same. This is true for any variation of a wind turbine which rotates around a vertical axis, regardless of the number of blades or blade design. The rotational line around the blade shows one example of the axis around which the blade would be likely to pitch on a vertical axis wind turbine.

Computerized controller 14 can also be configured such that it is in electrical communication with generator 10 such that controller 14 can modulate the electrical output of generator 10 based upon any of the foregoing sensor inputs or other data elements. In any version of the first embodiment drivetrain system 1, the first electrical output of generator 10 can be directly or indirectly transmitted to an inverter 15, a battery 33 or both. In a more preferred embodiment, the system includes an inverter 15 that receives the first electrical output of the generator. Inverter 15 is in electrical communication with the controller 14. Controller 14 can control inverter 15 by virtue of outputting a signal that causes inverter 15 to create an electrical load which will cause the flywheel to store or release (adjust) energy based upon the controller receiving the signals and data elements discussed above. Similarly, as shown in FIGS. 4 and 5, systems 1, 101 may include inverter power control system 30. Inverter 15 may have operative conditions that may be measured and which control system 30 can use to supply inputs for controller 14. Those inverter power control system 30 inputs are particularly useful in modulating flywheel 8. Note that in FIGS. 4 and 5, the two main elements of control are the: inverter power control system 30 and the CVT and/or blade pitching controller 14. While these may be functionally part of a single controller, they are depicted separately in the figures merely to represent different functions. The inverter and power electronics controller 30 regulates output power from the system by controlling power put into the grid from inverter 15. Controller 14 can also modulate the generator energy output by outputting a signal that causes the delivery of the generator energy output to a battery charging system, a rectifier-inverter system or an electrical inverter. The CVT and/or blade pitching control system 14 will dictate the CVT ratio and blade pitches.

As shown in FIGS. 4 and 5, generator 10 may include a brake to slow down systems 1, 101 in high wind speed scenarios. The embodiment systems can include a brake that alters the application of a braking force on the rotor, flywheel or generator so as to modulate the rotor-outputted rotational energy. In the figures, controller 14 is in electrical communication with rotor brake 24 (figuratively shown as housed within rotor 2 in FIGS. 6 and 7) and based upon the controller receiving the signals and data elements discussed above transmits a signal to rotor brake 24 that causes the rotor brake to alter a braking force on the rotor. The figures also depict the systems as having a generator brake. Either system could include a flywheel brake for handling of very high wind speeds.

Additionally, the depicted configurations show sensors measuring wind turbine rotor speed, CVT input and output speed, blade pitches, and flywheel speed (which will be used to calculate the total energy stored at any given time). While all of these values are preferable to control the system, if any of these can be calculated or estimated based on values given by the rest of the system, the particular sensor may be omitted. For example, knowledge of flywheel speed and the CVT and gearbox ratios will allow for calculation of rotor speed, meaning that the HAWT or VAWT rotor sensor may not be required. Wind speed may be measured through an on-site sensor, or a remote wind speed monitoring system in the local area. Wind speed, however may be possible to calculate with knowledge of blade pitch, CVT and gearbox ratios, flywheel speed, and power being output to the grid. Predictive elements may enhance system performance but are not critical to system operation and the system may be built without them.

The inventive concepts described above can be utilized with all wind turbines and is particularly effective for turbines producing less than 100 kW of output power. The inventive concepts explained herein may be utilized in a multitude of wind turbine applications, can be used with any type of turbine blades and can be adapted for use with hydro power turbines. The described inventive wind turbine drivetrain systems 1, 101 could be beneficially applied to supply electricity to a specific building. In this deployment, flywheel control can be optimized to reduce peak demand of a building. In addition, future demand predictions can be used as input to tell the flywheel to store more energy if a large period of high demand is expected from the grid. The power electronics may also be used to react to large demands, providing more power from the flywheel when a spike or increase in demand is sensed. Cost of electricity at different demand levels may be fed into the system as an input as well, in order to determine how to value energy use and losses at different times. In the event that more power needs to be taken out to maintain safe operation, a conventional braking system may be utilized.

With respect to deploying the inventive drivetrain systems to supply electricity to a specific building, the configurations may apply to any wind turbine, including those with a horizontal or vertical axis. In addition, the embodiment systems may apply to wind turbines which use the Venturi effect to accelerate wind before it hits the turbine blades, so that it reaches them at a faster speed. Furthermore, the embodiment systems may apply to building-integrated turbines which sit at the edge of the roof, using faster wind speeds that naturally occur at the roof edge in order to get power out more efficiently. In this last scenario, the turbine may either be placed so that it naturally picks up on the faster wind speeds at the edge of the roof, or may employ a channel to guide the wind towards the turbine blades in an optimal way. These scenarios include capture of faster wind speeds on the edge of a commercial and industrial roof, attached either directly to the parapet or to the building in a location close to the building parapet.

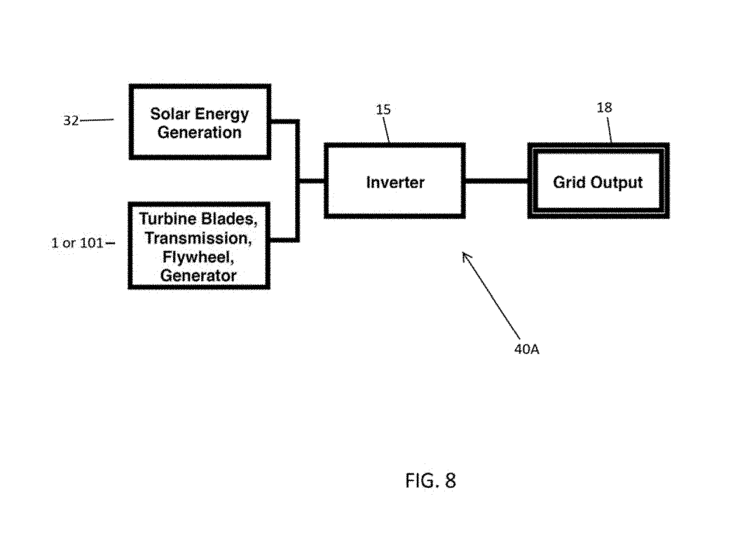

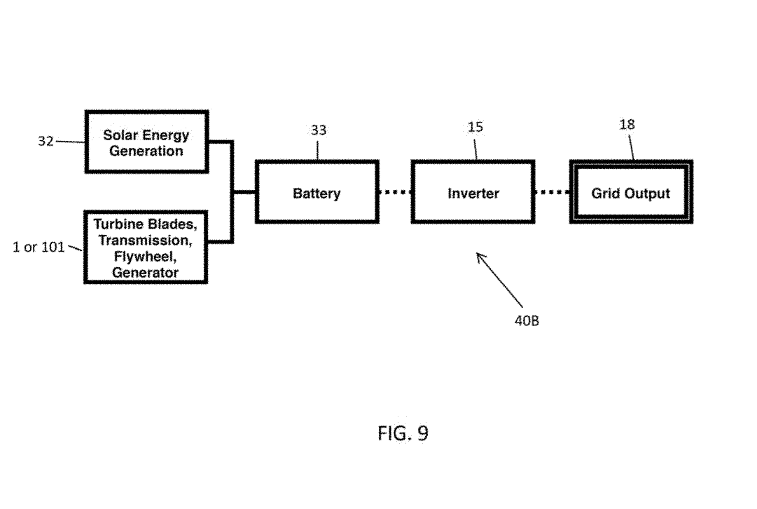

If channeling is used to direct the wind towards the turbine, the channel may be combined with solar energy generation component 32 on top of the channel. FIGS. 8 and 9 schematically show how the present invention wind turbine drivetrains could be utilized in combination with a solar energy system 32 to supply power to a grid. When combined on a building, or in an area with solar energy, the system may integrate the solar energy into the control scheme, diverting energy from the solar panels to artificially increase the flywheel speed, and thus stored energy, more quickly than might be possible with wind alone. This will help to more rapidly achieve a more efficient tip speed ratio. The wind and solar technology may also share common power conversion electronics.

FIG. 8 shows energy generation and distribution system 40A that includes solar energy generation system 32 and turbine using drivetrain system 1 or 101. Solar energy generation system 32 and system 1, 101 transmit electricity to the same inverter 15, which distributes electricity to grid 18. FIG. 9 shows how an embodiment of the present invention wind turbine drivetrain system can be included in a power generation and distribution system 40B that includes a solar energy generation system 32 and battery 33. In depicted system 40B, solar energy generation system 32 and embodiment of the inventive drivetrain system 1, 101 deliver electricity to the same battery 33 and inverter 15.

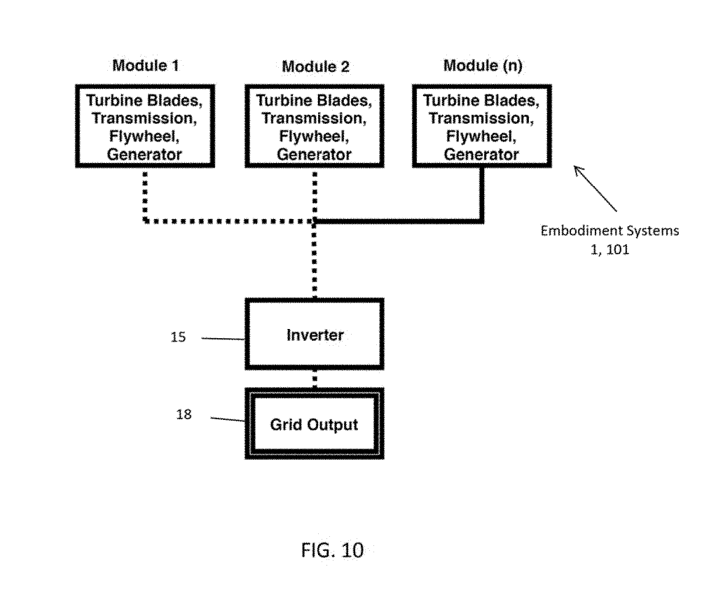

The present invention wind turbine drivetrain systems may be utilized in modular system where multiple wind turbine modules (utilizing embodiments of the inventive drivetrain systems 1, 101) are connected together to provide total power for a building or area. This is shown in FIG. 10. In this configuration, it is possible that an individual flywheel would be used with each module. Alternatively, the system may also include a modular system where the rotors of multiple wind turbines are physically linked to one larger flywheel/generator/inverter. Such linkages may be achieved through a CVT or through blade pitching in order to manage spacial wind speed variations. Finally, this configuration may include a system in which the power from the wind turbine is transmitted through the tower holding up the wind turbine before reaching the flywheel, either before or after the CVT.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment(s) were chosen and described in order to best explain the principles of the present invention and its practical application.

What is claimed is:

1. A drivetrain system for a wind turbine, the system comprising:
a rotor comprising a plurality of blades connected to a hub;
a continuously variable transmission (CVT), a flywheel and a generator;
the rotor having a rotor speed and outputting a rotor-outputted rotational energy,
the rotor being coupled to the CVT by a first mechanical coupling that transfers the rotor-outputted rotational energy to the CVT;
the CVT having a CVT ratio and outputting a CVT-outputted rotational energy, the CVT being coupled to the flywheel by a second mechanical coupling that transfers the CVT-outputted rotational energy to the flywheel;
the flywheel having a flywheel speed and outputting a flywheel-outputted rotational energy, the flywheel being coupled to the generator by a third mechanical coupling that transfers the flywheel-outputted rotational energy to the generator; and
the generator producing a generator energy output based on the flywheel-outputted rotational energy received from the third mechanical coupling.

2. The system of claim 1 further including a controller in electrical communication with one or more of the CVT, the flywheel and the generator, the controller outputting a signal that causes the modulation of one or more of the CVT ratio and the generator energy output.

3. The system of claim 2 wherein the controller outputs a signal that causes the modulation of one or more of the CVT ratio and the generator energy output based upon one or more data elements received by the controller in the form of a sensor input or data input.

4. The system of claim 3 wherein the one or more data elements are selected from the group consisting of a wind speed data element, a rotor speed data element, a flywheel speed data element and a generator energy output data element.

5. The system of claim 4 wherein:
the wind turbine has a determined optimal efficiency tip speed ratio;
the wind turbine when operating has an operating tip speed ratio; and
the controller modulates one or more of the CVT ratio and the generator energy output in furtherance of having the operating tip speed ratio equal or approach the determined optimal efficiency tip speed ratio.

6. The system of claim 4 wherein:
the system is connected to a grid providing electricity to consumers, the consumers having an electric usage demand that can be predicted and used as a data input for the controller; and
the controller's modulation of one or more of the CVT ratio and the generator energy output is also based upon a data input as to predicted electrical usage demand.

7. The system of claim 4 wherein the generator energy output of the generator is transmitted to an inverter, a battery or both.

8. The system of claim 4 wherein the controller is in electrical communication with an inverter, the controller outputting a signal that causes the inverter to create an electrical load that results in a change in energy stored in the flywheel or generator.

9. The system of claim 4 wherein the controller is in electrical communication with a battery, the controller outputting a signal that causes the battery to create an electrical load that results in a change in energy stored in the flywheel or generator.

10. The system of claim 4 wherein either or both of the first mechanical coupling and second mechanical coupling includes or is connected to a gearbox.

11. The system of claim 4 wherein:
one or more of the plurality of blades have an orientation relative to the hub;
the system includes a blade pitch control mechanism that alters the orientation of the one or more of the plurality of blades;
the controller is in electrical communication with the blade pitch control mechanism; and
the controller outputs a signal that causes the blade pitch control mechanism to alter the orientation of one or more of the plurality of blades.

12. The system of claim 4 further including a brake in electrical communication with the controller, the brake when actuated altering the application of a braking force on one or more of the rotor, the flywheel or the generator.

13. A drivetrain system for a wind turbine, the system comprising:
a rotor comprising a plurality of blades connected to a hub; one or more of the plurality of blades have an orientation relative to the hub;
a blade pitch control mechanism, the blade pitch control mechanism altering the orientation of the one or more of the plurality of blades;
a flywheel and a generator;
the rotor having a rotor-outputted rotational energy;
the rotor being coupled to the flywheel by a first mechanical coupling that transfers the rotor-outputted rotational energy of the rotor to the flywheel;
the flywheel outputting a flywheel-outputted rotational energy and being coupled to the generator by a second mechanical coupling that transfers the flywheel-outputted rotational energy to the generator; and
the generator producing a generator energy output based upon the flywheel-outputted rotational energy received from the first mechanical coupling.

14. The system of claim 13 further including a controller in electrical communication with one or more of the blade pitch control mechanism, the flywheel and the generator, the controller outputting a signal that causes the modulation of one or more of the orientation of the one or more of the plurality of blades and the generator energy output.

15. The system of claim 14 wherein the controller modulates one or more of the orientation of the one or more of the plurality of blades and the generator energy output based upon one or more data elements received by the controller in the form of a sensor input or data input.

16. The system of claim 15 wherein the one or more data elements are selected from the group consisting of a blade pitch data element, a wind speed data element, a flywheel speed data element and a generator output data element.

17. The system of claim 16 wherein:
the wind turbine has a determined optimal efficiency tip speed ratio;
the wind turbine when operating has an operating tip speed ratio; and
the controller modulates one or more of the orientation of the one or more of the plurality of blades and the generator energy output in furtherance of having the operating tip speed ratio equal or approach the determined optimal efficiency tip speed ratio.

18. The system of claim 16 wherein the controller is in electrical communication with one or more of an inverter or battery, the controller outputting a signal that causes one or more of the inverter or battery to create an electrical load that results in a change in energy stored in the flywheel or generator.

19. The system of claim 16 wherein either or both of the first mechanical coupling and second mechanical coupling includes or is connected to a gearbox.

20. The system of claim 16 further including a brake in electrical communication with the controller, the brake when actuated altering the application of a braking force on one or more of the rotor, the flywheel or the generator.
